(19) United States
(12) Patent Application Publication
(10) Pub. No.: US 2008/0220113 A1
(43) Pub. Date: Sep. 11, 2008

(54) INSERT MOLDING ARTICLE AND METHOD FOR MAKING THE SAME

(75) Inventor: QIAN-LONG LIAO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/741,749

(22) Filed: Apr. 29, 2007

(30) Foreign Application Priority Data
Mar. 7, 2007 (CN) 200710200255.2

(51) Int. Cl. B29B 13/00; B29C 39/00

(52) U.S. Cl. 425/467; 264/271.1

(57) ABSTRACT

An exemplary insert molding article includes a plastic element and an insert element. The insert element includes a main portion, an extension portion extending out from one side surface of the main portion, and a cutout defined at an outer corner of the extension portion adjacent to a center of the main portion. The extension portion is partly enclosed by the plastic element. The plastic element includes a matching protrusion corresponding to the cutout of the extension portion. Methods for making the insert molding article are also provided.

### BACKGROUND OF THE INVENTION

1. Field of the Invention

The present invention relates, generally, to an insert molding article, and, particularly, to an insert molding article including a plastic element and an insert element made of other materials, and method for making the insert molding article.

2. Discussion of the Related Art

Some workpieces include portions respectively made of different materials. Many kinds of these workpieces are manufactured by means of insert molding, i.e., they are insert molding articles. For example, a housing of an electronic device includes a plastic element and an insert element made of another material. When the housing is manufactured, the insert element is placed in a mold, and melted plastic is injected into the mold. After the melted plastic solidifies, the plastic element is formed on the insert element, and the housing is completed.

Referring to FIGS. 3 and 4, a housing 10 of an electronic device is made up of an insert element 12 and a plastic element 14. The insert element 12 is made of one or more inorganic or organic materials, such as metal, glass, polycarbonate, etc, and a melting point of the insert element 12 is higher than that of the plastic element 14. The insert element 12 includes a main portion 122 and an extension portion 124. The main portion 122 is a first board. The extension portion 124 is a second board formed on one end of a side of the main portion 122, extending approximately perpendicularly from there. The plastic element 14 includes a receiving portion 142 and a sidewall 144 located on a periphery of the receiving portion 142. The insert element 12 is partly enclosed by the sidewall 144 of the plastic element 14. The insert element 12 is located at the same side of the receiving portion 142. In production, the insert element 12 of the housing 10 is placed in a mold, and melted plastic is injected into the mold. After the melted plastic solidifies, the plastic element 14 is thereby formed on the insert element 12 and attached on/to a side of the sidewall 144, and the housing 10 is completed.

Generally, an area of the plastic element 14 is very larger than that of the insert element 12, thus a gate of the mold used to form the plastic element 14 is configured to be adjacent to a center of receiving portion 142 of the plastic element 14. Therefore, the sidewall 144 partly surrounding the insert element 12 is far away from the gate. When the melted plastic is injected at a high temperature into the mold via the gate, the melted plastic is divided into a plurality of melted plastic flows by an injection pressure. The melted plastic flows flow into distant portions of a molding cavity of the mold respectively, and finally meet to fill the molding cavity. It is to be understood that, because the meeting of the melted plastic flows in the distant portions are relatively late, adhesive properties of the melted plastic flows is correspondingly reduced, thus a plurality of joint lines occur when the melted plastic flows in contact with each other. Although, the joint lines are almost invisible to the human eye, the joint lines can be shown just by a slight burning method known by ordinary engineers.

In the housing 10, a joint line occurs at a portion A along a side surface of the extension portion 124, the side surface adjacent to the center of the main portion 122. Therefore, a bonding strength of the portion A of the housing 10 is weak. The housing 10 is prone to split along the joint line of the portion A when the housing 10 is applied pressing in assembling. Therefore, electronic devices using the housing 10 may not pass quality control checks and are considered as low yield devices.

What is needed, therefore, is an insert molding article that overcomes the above mentioned disadvantages. Methods for making the insert molding article are also desired.

### SUMMARY

In one aspect, an insert molding article according to a preferred embodiment includes a plastic element and an insert element. The insert element includes a main portion, an extension portion extending out from one end of one side surface of the main portion, and a cutout defined at an outer corner of the extension portion adjacent to a center of the main portion. The extension portion is partly enclosed by the plastic element. The plastic element includes a matching protrusion corresponding to the cutout of the extension portion.

In another aspect, a method for making an insert molding article includes: providing an insert element, the insert element including a main portion, an extension portion extending out from one end of one side surface of the main portion, and a cutout defined at an outer corner of the extension portion adjacent to a center of the main portion; placing the insert element into a mold; injecting one or more resin materials into the mold to form the insert molding article, the insert molding article further comprising a plastic element, wherein the extension portion is partly enclosed by the plastic element, and the plastic element comprises a matching protrusion corresponding to the cutout of the extension portion.

In still another aspect, a method for making an insert molding article includes: injecting one or more first melted resin materials into a first mold to form an insert element; placing the insert element into a second mold; injecting one or more second resin materials into the second mold to form the insert molding article, the insert molding article comprising an insert element having a main portion, an extension portion extending out from one end of one side surface of the main portion, and a cutout defined at an outer corner of the extension portion adjacent to a center of the main portion; and a plastic element, wherein the extension portion is partly enclosed by the plastic element, and the plastic element comprises a matching protrusion corresponding to the extension portion.

Other advantages and novel features will become more apparent from the following detailed description of the preferred embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present insert molding article and method for making the insert molding article. Moreover, in the drawings, like reference numerals designate corresponding parts throughout the several views, and all the views are schematic.

FIG. 1 is an isometric view of an insert molding article according to a preferred embodiment of the present invention.

FIG. 2 is an exploded, abbreviated, enlarged view of the insert molding article of FIG. 1.

FIG. 3 is an isometric view of a conventional insert molding article.

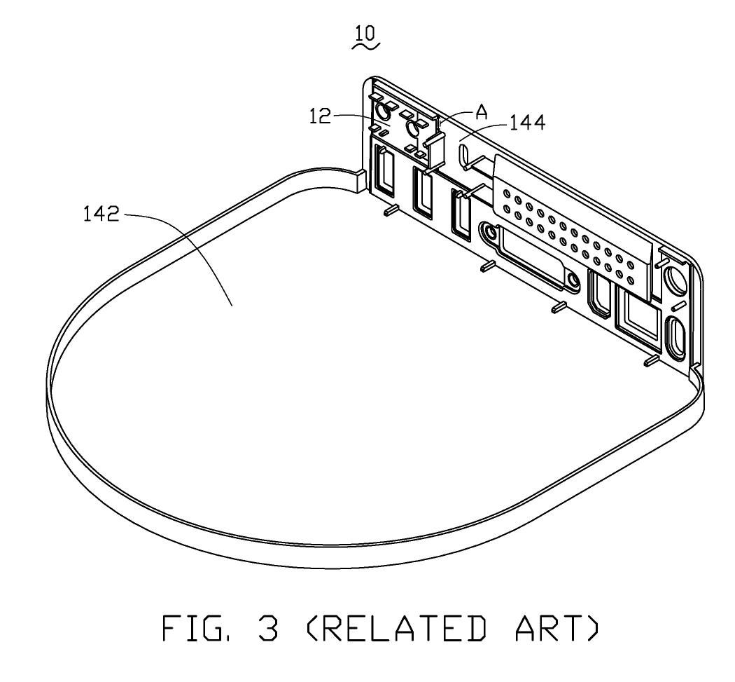

FIG. 4 is an exploded, abbreviated, enlarged view of the insert molding article of FIG. 3.

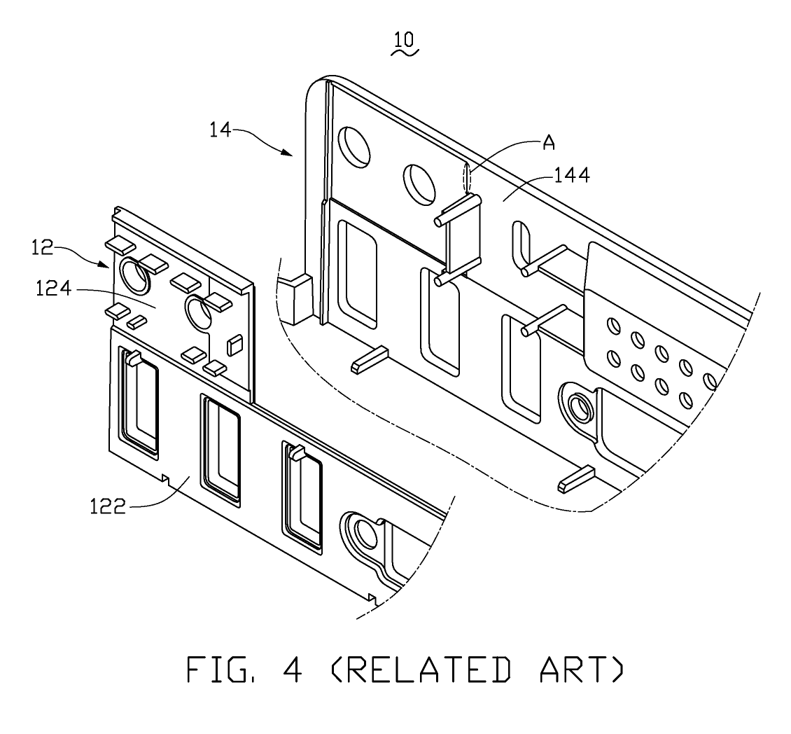

### DETAILED DESCRIPTION OF THE PREFERRED EMBODIMENTS

Reference will now be made to the drawings to describe preferred embodiments of the present insert molding article and methods for making the insert molding article, in detail.

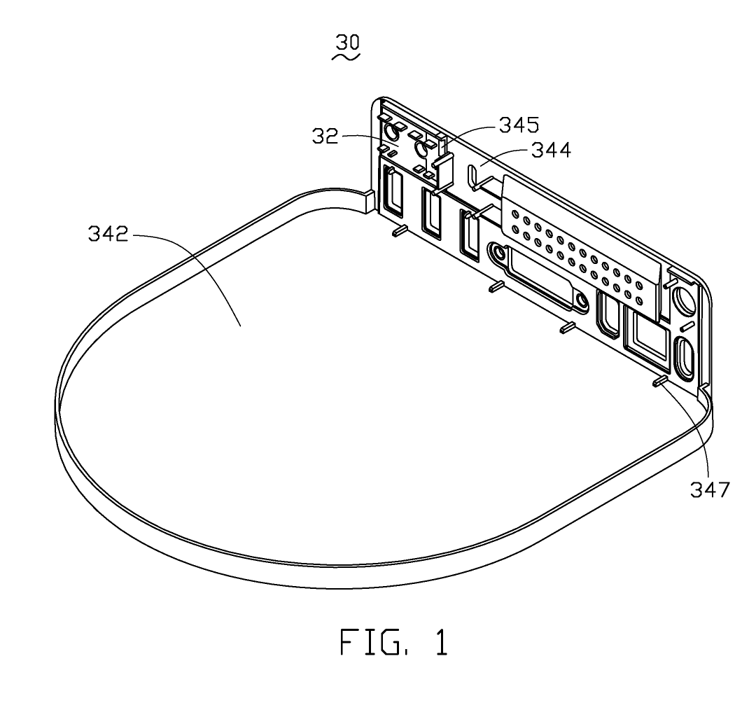

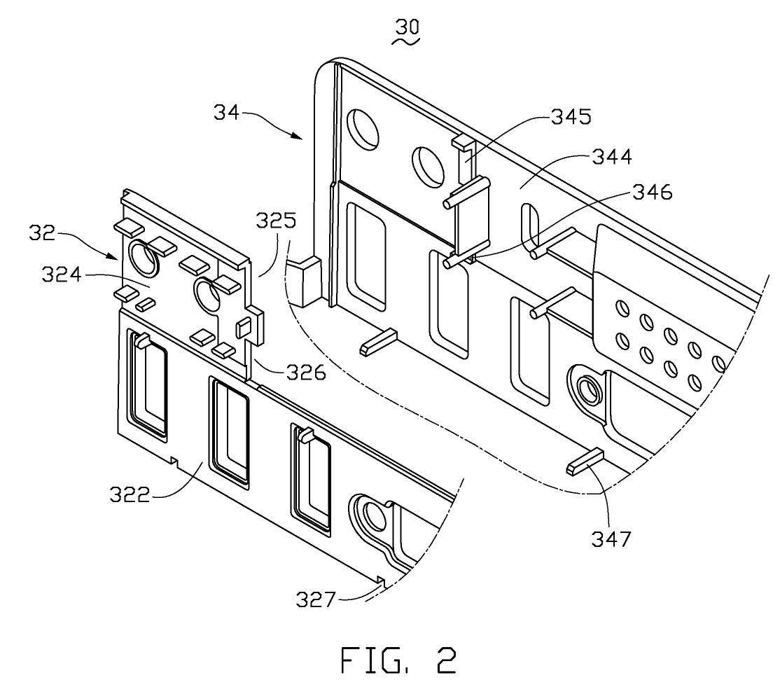

Referring to FIGS. 1 and 2, an insert molding article 30 in accordance with a preferred embodiment of the present invention is shown. The insert molding article 30 can be used as a part of a housing of an electronic device. The insert molding article 30 includes an insert element 32 and a plastic element 34. The insert element 32 includes a main portion 322 and an extension portion 324. The main portion 322 is a first board. The extension portion 324 is a second board extends from a side of the main portion 322. Preferable, as seen in FIG. 2, the extension portion 324 extends perpendicularly from an outer end of the side of the 322. The main portion 322 and the extension portion 324 cooperatively define an approximate “L” letter in shape. The extension portion 324 defines a first cutout 325 and a second cutout 326. The first cutout 325 is defined at a first corner of the extension portion 324. Preferable the 325 is defined at an upper corner of the 324 opposite the outer end of the 322. The second cutout 326 is defined at a lower corner of extension portion 324 adjacent to a center of the main portion 322 of the insert element 32. The insert element 32 is made of one or more inorganic or organic materials, such as metal, glass, polycarbonate, etc. In this embodiment, the insert element 32 is made of polycarbonate.

The plastic element 34 includes a receiving portion 342 and a sidewall 344 located on a periphery of the receiving portion 342. The insert element 32 is partly enclosed by the sidewall 344 of the plastic element 34. The insert element 32 is located at an inner surface of the sidewall 344 facing the receiving portion 342. The plastic element 344 further includes a first matching protrusion 345 corresponding to the first cutout 325 and a second matching protrusion 346 corresponding to the second cutout 326. Accordingly, when the insert element 32 is received in the plastic element 34, the first and second matching protrusions 345, 346 complete the two corners of the extension portion 324. Each of the first and second matching protrusion 345, 346 has a flat side extremity coplanar with an outer surface of the extension portion 324. Therefore, a mechanical intensity of this part of the insert molding article 30 is increased. The plastic element 344 is made of acrylonitrile-butadiene-styrene (ABS).

Referring to FIGS. 1 and 2, the insert element 32 can further define a plurality of openings 327, etc. The plastic element 34 may further include a plurality of positioning pins 347 corresponding to the openings 327. The positioning pins 347 are inserted in the openings 327 correspondingly.

It should be pointed out that, the second cutout 326 of the insert element 32 and the second matching protrusion 346 of the plastic element 34 can be omitted. The insert molding article 30 is manufactured by insert molding method. In production, because the plastic element 34 defines the first matching protrusion 345 to match with the first cutout 325 of the extension portion 324 of the insert element 32, a mold designed for forming the plastic element 34 has a relatively larger molding space where the first matching protrusion 345 forms in. Accordingly, the melted plastic flows enter the molding space with a relatively larger flow rate by a larger injection pressure, such that a joint line of at least two melted plastic flows can be changed and staggered relative to a direction along the side surface (not labeled) of the extension portion 324 adjacent to the center of the main portion 322. Therefore, when the insert molding article 30 is applied pressing in assembling, the insert molding article 30 will not prone to split along the side surface.

An exemplary method for making the insert molding article 30 of FIG. 1 will now be described. The method mainly includes the following three steps.

Step one: a first mold is provided for injection molding the insert element 32. In this embodiment, melted polycarbonate (PC) is injected into the first mold. After the melted PC solidifies, the insert element 32 is thereby formed.

Step two: a second mold is provided for forming the insert molding article using insert molding method. The insert element 32 is placed in the second mold. Before this step, the second mold should be accurately designed base on an actual size of the insert element 32. Therefore, the calculation of a shrinkage rate of the insert element 32 is very important.

Step three: a melted ABS is injected into the second mold to form the insert molding article. A melting point of the ABS is higher than that of the polycarbonate.

It is to be understood that, another exemplary method for making an insert molding article includes following steps. An insert element is provided, and the insert element is made of either glass or metal. The insert element is placed into a mold. One or more resin materials into the mold to form the insert molding article.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. An insert molding article, comprising:
an insert element including a main portion, an extension portion extending out from one side surface of the main portion, and a first cutout defined at an outer corner of the extension portion adjacent to a center of the main portion; and
a plastic element, wherein the extension portion is partly enclosed by the plastic element, and the plastic element comprises a first matching protrusion corresponding to the cutout of the extension portion.

2. The insert molding article according to claim 1, wherein a melted temperature of the insert element is higher than that of the plastic element.

3. The insert molding article according to claim 2, wherein the insert element is made of polycarbonate.

4. The insert molding article according to claim 2, wherein the plastic element is made of acrylonitrile-butadiene-styrene.

5. The insert molding article according to claim 1, wherein insert element further comprises a second cutout defined at an inner corner of the extension portion adjacent to the center of the main portion; the plastic element further comprises a second matching protrusion corresponding to the second cutout.

6. A method for making an insert molding article, comprising:
providing an insert element, the insert element including a main portion, an extension portion extending out from one end of one side surface of the main portion, and a cutout defined at an outer corner of the extension portion adjacent to a center of the main portion;
placing the insert element into a mold;
injecting one or more resin materials into the mold to form the insert molding article, the insert molding article further comprising a plastic element, wherein the extension portion is partly enclosed by the plastic element, and the plastic element comprises a matching protrusion corresponding to the cutout of the extension portion.

7. The method for making an insert molding article as claimed in claim 6, wherein a melted temperature of the insert element is higher than that of the plastic element.

8. The method for making an insert molding article as claimed in claim 7, wherein the insert element is made of polycarbonate.

9. The method for making an insert molding article as claimed in claim 7, wherein the plastic element is made of acrylonitrile-butadiene-styrene.

10. A method for making an insert molding article, comprising:
injecting one or more first melted resin materials into a first mold to form an insert element;
placing the insert element into a second mold;
injecting one or more second resin materials into the second mold to form the insert molding article, the insert molding article comprising an insert element having a main portion, an extension portion extending out from one end of one side surface of the main portion, and a cutout defined at an outer corner of the extension portion adjacent to a center of the main portion; and a plastic element, wherein the extension portion is partly enclosed by the plastic element, and the plastic element comprises a matching protrusion corresponding to the cutout of the extension portion.

11. The method for making an insert molding article as claimed in claim 10, wherein a melted temperature of the insert element is higher than that of the plastic element.

12. The method for making an insert molding article as claimed in claim 1, wherein the insert element is made of polycarbonate.

13. The method for making an insert molding article as claimed in claim 11, wherein the plastic element is made of acrylonitrile-butadiene-styrene.
